(19) United States
(12) Patent Application Publication
(10) Pub. No.: US 2007/0265831 A1
(43) Pub. Date: Nov. 15, 2007

(54) System-Level Correction Service

(76) Inventors: Itai Dinur, Haifa (IL); David Konopnicki, Haifa (IL)

Correspondence Address: IBM CORPORATION, T.J. WATSON RESEARCH CENTER, P.O. BOX 218, YORKTOWN HEIGHTS, NY, 10598, US

(21) Appl. No.: 11/382,281

(22) Filed: May 9, 2006

(51) Int. Cl. G06F 17/21

(52) U.S. Cl. 704/10

(57) ABSTRACT

A system-level text correction service (330) is provided. The service (330) includes monitoring (410) the input of text (340) on a computer system, identifying an incorrect input word in a first application. Correction proposal words are retrieved from a system-level dictionary (320), wherein the system-level dictionary (320) stores a reference word with an identifier of at least one application type in which the reference word is used. The correction proposal words are ranked according to the similarity of the proposal word to the input word and by comparing the first application to the application types of the reference word.

### FIELD OF THE INVENTION

This invention relates to the field of correction services which provide suggested corrections for unrecognised textual terms. In particular, the invention relates to a computer system-level correction service.

### BACKGROUND OF THE INVENTION

Working with a computer through a text based interface can be a frustrating trial and error experience. Computer users and, in particular advanced users, often need to remember long and complicated computer commands, file paths, program arguments, etc. Furthermore, given the complexity of computer systems this is unlikely to change.

This problem has been partly solved in two domains: word processors and integrated development environments (IDE) (for example, Eclipse™ (of Eclipse Foundation) an open source platform-independent software framework). Most word processors automatically correct words as a user types using a dictionary based spell checker. Similarly, modern IDEs are able to propose word completions as a user types based on the type system defined in an application.

However, these solutions are limited because they are too static. Every application must build its own correction functionality. When an application proposes such a functionality, it is limited to the small set of data inputted and/or accessible to the application. Too often, automatic correction cannot be applied because the correction function does not have access to the data needed to do the correction.

In a parallel field, search functionality has in the past been implemented by individual applications independently. For example, a search in email, a search in a file system, a search in code files, etc. The search system is now becoming a system-level service that different applications can use to store their data and make it searchable. Search indexes are becoming foundation services provided on a desktop, as part of the operating system of personal computers, or enterprise servers.

A specialized search facility can be provided on a desktop of a personal computer. An example is Google Desktop Search™ (of Google Inc.) which provides searches and access to information on a personal computer. It is a desktop search application that provides full text search over documents including: email, instant messages, computer files, media files such as music, video and photos, and web pages that have been viewed.

System-wide search engines can also be provided as part of an operating system of a computer. For example, Spotlight in Mac OS X v10.4 Tiger (Spotlight™, Mac™ and Tiger™ are of Apple Computer Inc.) and Longhorn™ (of Microsoft Corporation) provide search facilities as part of their operating systems in which applications and documents can be searched.

Applications running on such systems do not implement their search features independently, as done in the past but, instead, index their data as part of the system-wide index. For example, an instant messaging application that wants to provide a searchable history of messages does not need to implement this feature but must push the messages to the global index provided by the operating system or by the specialized search service. In order to do so, providers of search technology publish APIs that allow applications to push their data into their index (e.g., Google Desktop Search API).

Thus, these system-level search has access to a large part of the information available on a computer.

### SUMMARY OF THE INVENTION

It is an aim of the present invention to provide a system-level correction service available in every application on a computer system that is built on the combined resources across applications.

According to a first aspect of the present invention there is provided a method for providing a correction service, comprising: monitoring the input of text; identifying an incorrect input word in a first application; retrieving one or more correction proposal words from a system-level dictionary, wherein the system-level dictionary stores a reference word with an identifier of at least one application type in which the reference word is used; and ranking the correction proposal words according to the similarity of the proposal word to the input word and by comparing the first application to the application types of the proposal word.

According to a second aspect of the present invention there is provided a system for providing a correction service, comprising: a monitor of input of text on a computer system, including an identifier of an input word in a first application; a system-level dictionary, wherein the dictionary stores a reference word with an identifier of at least one application type in which the reference word is used; a means of comparing the input word and reference words in the system-level dictionary according to the similarity of a reference word to the input word and by comparing the first application to the application types of the reference word.

According to a third aspect of the present invention there is provided a computer program product stored on a computer readable storage medium, comprising computer readable program code means for performing the steps of: monitoring the input of text; identifying an incorrect input word in a first application; retrieving one or more correction proposal words from a system-level dictionary, wherein the system-level dictionary stores a reference word with an identifier of at least one application type in which the reference word is used; and ranking the correction proposal words according to the similarity of the proposal word to the input word and by comparing the first application to the application types of the reference word.

According to a fourth aspect of the present invention there is provided a method of providing a service to a customer over a network, the service comprising: monitoring the input of text; identifying an incorrect input word in a first application; retrieving one or more correction proposal words from a system-level dictionary, wherein the system-level dictionary stores a reference word with an identifier of at least one application type in which the reference word is used; and ranking the correction proposal words according to the similarity of the proposal word to the input word and by comparing the first application to the application types of the reference word.

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:
FIG. 1 is a block diagram of a known computer system in which the present invention may be implemented;
FIG. 2 is a block diagram of system-level search system as known in the art;
FIG. 3 is a block diagram showing a system-level correction service in accordance with the present invention;
FIG. 4 is a block diagram showing further detail of a system-level correction service in accordance with the present invention;
FIG. 5 is a schematic representation of a dictionary of a correction service in accordance with the present invention; and
FIG. 6 is a flow diagram of a method of operation of a correction service in accordance with the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Referring to FIG. 1, an exemplary system for implementing the invention includes a data processing system 100 suitable for storing and/or executing program code including at least one processor 101 coupled directly or indirectly to memory elements through a bus system 103. The memory elements can include local memory employed during actual execution of the program code, bulk storage, and cache memories which provide temporary storage of at least some program code in order to reduce the number of times code must be retrieved from bulk storage during execution.

The memory elements may include system memory 102 in the form of read only memory (ROM) 104 and random access memory (RAM) 105. A basic input/output system (BIOS) 106 may be stored in ROM 104. System software 107 may be stored in RAM 105 including operating system software 108. Software applications 110 may also be stored in RAM 105.

The system 100 may also include a primary storage means 111 such as a magnetic hard disk drive and secondary storage means 112 such as a magnetic disc drive and an optical disc drive. The drives and their associated computer-readable media provide non-volatile storage of computer-executable instructions, data structures, program modules and other data for the system 100. Software applications may be stored on the primary and secondary storage means 111, 112 as well as the system memory 102.

The computing system 100 may operate in a networked environment using logical connections to one or more remote computers via a network adapter 116.

Input/output devices 113 can be coupled to the system either directly or through intervening I/O controllers. A user may enter commands and information into the system 100 through input devices such as a keyboard, pointing device, or other input devices (for example, microphone, joy stick, game pad, satellite dish, scanner, or the like). Output devices may include speakers, printers, etc. A display device 114 is also connected to system bus 103 via an interface, such as video adapter 115.

Referring to FIG. 2, a block diagram shows a computer system 200 with a system-level search index 210 as known in the prior art. A plurality of applications 201-204 share the search index 210 and the search index 210 can also be connected to web search engines via a network. The search index 210 has a published indexing API allowing the applications 201-204 to index their data in the search index 210.

In prior art systems, the applications 201-204 may each have their own correction dictionary 211-214. For example, one application 201 may be a word processing application with a spell checking function which uses a fixed set of words in a chosen language together with words that have been set explicitly by the user. The application 201 will therefore have a dictionary 211 of fixed and custom words.

Referring to FIG. 3, a block diagram shows a computer system 300 as a representation of an embodiment of the present invention in which a system-level correction service 330 is provided. A computer system 300 includes a plurality of applications 301-304 and a system-level search engine 310. A system-level dictionary 320 is provided in the form of a dynamic dictionary of information in locations found across the computer system 300. A correction service 330 is provided which monitors text input, for example from a keyboard, scanner or other input means 340 of the computer system 300, regardless of the application 301-304 in which the text is input, and searches the system-level dictionary 320 for correction suggestions.

The correction service 330 works as follows. A system-level search engine 310 pushes data into its search index 312 as part of a routine update procedure. The system-level search engine 310 can also be used to build a full text system-level dictionary 320 of the information found on a computer. This full text dictionary is a dynamic dictionary and index of the information found in the computer.

The system-level dictionary 320 includes a list of words and the application types they are used in. The dictionary 320 may also include a counter and, in some cases, a context of the word as described further below.

The system-level dictionary 320 can be updated dynamically by the following methods:
The system-level search engine 310 monitors data changes occurring in the computer system 300 (for example, by monitoring changes to the file system). As a result, when changes are detected, data is pushed into the search index 312 as part of routine update procedure. This data is also pushed into the dictionary 320.
An application 301-304 uses an API to explicitly add words to the dictionary 320.

This can happen at any given time that the application 301-304 is running. An application 301-304 may also drop to disk its internal dictionary as a file in a format recognized by the system-level search engine 310. As a consequence, the system level search engine will update the system level dictionary 320 as part of its routine update procedure described above.
The user explicitly adds data to the dictionary 320.

When text is input, the correction service 330 capture the input from an input means 340 at the operating system level. This may be by key stoke capture from a keyboard, or capture during a character recognition means from scanned input text, voice recognition conversion to text, or any other form of text input into the computer system. The correction service 330 saves a set of input words of configurable size. The user, using a special key combination, or the service, if it detects a likely error in an input word, prompts a look-up of similar words to the input word in the dictionary. The correction service 330 analyzes possible correction proposals and provides a list of ranked correction proposals for the input word. In order to improve the relevance of the proposals, various parameters are used to rank the proposals.

Referring to FIG. 4, further details of an embodiment of the correction service 330 are shown. The correction service 330 has an input monitor 410 which monitors the input by a text input means 340 of the computer system which may be of the form discussed in relation to FIG. 3. The text input may be natural language, for example a word processing application, or programming language (for example, commands, file paths, program arguments, etc) in a computer programming application, or any other form of text input. The term “word” is used for a unit of input text; however, if the input text is a computer language or command the terms may be in the form of a string of characters that is not a natural language word.

The correction service 330 includes a recording module 420 for recording a set of last words input into the computer system. The set of last words may be recorded from an input into any application 301-304 running on the computer system. The number of last words provided in the set may be configured by a user. The set may be in the form of a window of input words.

The correction service 330 has a prompt or trigger mechanism 430. The prompt mechanism 430 may be activated by a user initiated prompt, such as a special key configuration or a mouse click on a button. Alternatively, the prompt mechanism 430 may be activated by the detection of a potential error in the spelling of an input word. The prompt mechanism 430 instigates a look-up of the word in the system-level dictionary 320. The look-up provides a list of proposed words for correction of the input word.

A suggestion analyzer 422 is provided to analyze the suggested proposals for correction retrieved from the dictionary 320 in order to rank the proposals according to a number of parameters to be discussed below.

The correction service 330 also includes an activity link module 424. A separate data structure is maintained that links documents to activities. Every time that the user opens several documents simultaneously, those files are linked with a new activity in the data structure. When generating corrections for a word in a document D, words in documents that are linked to document D with an activity will receive a boost in ranking.

The correction service 330 includes a display means 440 for displaying the correction proposals to the user.

The correction service 330 includes a monitor 460 which monitors data used by users in a given context and improves the ranking of proposals over time.

Although all the above components are described as part of the correction service 330 they may be provided separately or in combined form in a service application, as part of the system-level dictionary 320, or as part of a system-level search facility.

The correction service 330 may be connected to a network 470. The network 470 may be a public network such as the Internet, a private Intranet, etc. The correction service 330 may be provided to remote users 480 via the network 470.

A local correction service 330 may also connect to a global correction service 490 via a network 470. A global correction service 330 may be provided for a specific subject (for example, a computer language) and a local correction service 330 may connect to a global correction service 490 based on the user's interests.

An important aspect is how possible corrections of an input word are ranked. Proposed corrections are ranked according to one or more of five parameters:

1) The similarity of the correction to the corrected word.

2) The application type.

3) The context of the word.

4) Document activities.

5) The user's history.

1) The similarity of the correction to the corrected word: This is the basic algorithm for spelling correction. It is computed by using the dictionary and looking for words within a specified edit distance from the input word.

For example, the word “corbection” can be corrected by “correction” and “connection”, “correction” has a higher similarity to “corbection”, and will be ranked higher. Corrections with low similarity will not be displayed.

Typing the English word “nime” may result in the following correction list: “Nike”, “name”, “mime”, “nine”. Typing the dos command “com” may result in the following correction list: “command”, “comp”, “copy”.

2) Given a word W, it is associated in the system-level dictionary 320 with all the applications in which it appears together with their types. Corrections coming from the same type of application as the input word are preferred.

The application type can be determined by the application from which the correction service is called (e.g. Word processor, Unix shell, DOS shell, chat, etc.). The correction service maintains an identifier for every type of application in the system. A type of application will be added to the correction service in one of the two ways:
a) The application will specify its type by an API published by the correction service.
b) The user will specify a certain application's type explicitly.

3) The context of the word is computed by comparing the context of the input word with the contexts of the proposed corrections.
For the input word, a context is supplied by the operating system according to the set of words that surrounds the input word. For the each of the proposed corrections, the context comes from the system-level dictionary 320 with reference to the system-level search index 312 that associates a word in the dictionary 320 with each document on the computer system in which the word appears and at which positions.

A context of a word X is defined as the set of words of size n that appears around word X in the application together with the identifier of the file in which those words are found if any. The string of words in the window can be examined to evaluate the likelihood of such a word combination.

Given a list of consecutive words, the search index 312 contains all the information needed to compute if those words are contained in some document within some set of words. For example, to correct word b, which appears within the context a b c, a set of corrections for b is provided: b1, b2, etc . . . . For each of the corrections, the search index 312 is looked at to find a set of words in a document which contains a b1 c or a b2 c and the size of the set of words containing the context is noted. The corrections that appear in the smaller sets of words are ranked higher.

In a case where correction c was explicitly added to the dictionary 320 by an application 301-304, the context of c that is supplied by the application is actually stored in the dictionary 320 next to the word (in addition to the context that is obtained from the search index 312—if it exists).

In the case where correction c was explicitly added to the dictionary by the user, the context of c is determined by the words surrounding c, and is stored in the search index 312, with the document.

4) Document activities. In general, the operating system maintains a log of open documents at a given time. This is a functionality provided by most modern operating systems and, if not, it is straightforward to implement. Intervals in which a certain document was open and modified are retrieved. For example, if a document D is being corrected. At correction time, it will be preferred to provide proposed correction words that belong to documents that have been usually opened at the same time as the document D since they will usually belong to the same activity.

5) The user's history: This parameter has nothing to do with the input word. The dictionary 320 maintains, for each word in the dictionary, a counter that represents the number of times that the user has selected this word as a correction. Each time that a user selects a certain correction, its counter is incremented. At correction time, corrections with be boosted in ranking according to their counter value.

When the list of proposed corrections is generated for an application, the correction service 330 takes into consideration the above parameters in order to sort the correction suggestions.

The correction service 330 also includes an API to allow applications 301-304 to customize the data used in the correction service 330. The API publishes the location of data that should be used for the correction service 330 in a context and updates the data used for the correction service 330 in the context.

The API's main method would be:
void addWord(String word, String[ ] context, Properties prop)

The implementation of this API would add the specified word to the dictionary 320 with the given neighboring words context. The properties are dynamic optional properties (e.g. language). The application type is determined according to the application 301-304 that calls this API.

Ranking is improved over time. As the dictionary 320 expands, there will be more possible corrections available. Particularly, more highly ranked possible corrections will be available. More correction proposals will have the same neighboring word context, application type, or belong to the same activity as the input word. Corrections that have been previously chosen by the user will get a boost in ranking.

In this way, the same word which is used in different grammatical uses, in different applications, in different languages, or in different activities is ranked according to the relevance of the context of the dictionary referenced words to the context of the input word.

The system-level dictionary 320 is built by a system-level search engine 310 of all the words that are gathered from the various applications on a computer system. Applications can push data explicitly to the system-level dictionary 320. In addition, the system-level search engine 310 can be used to crawl manuals, encyclopaedias and other web resources via the network 470 to improve the dictionary used for corrections.

A system-level search engine builds a system-level dictionary of all the words that have been gathered from the various applications on a computer system. Such a system-level dictionary is different from an application-level dictionary as a dictionary at the system-level associates each word with one or more application types.

When a word Y is added to the correction service by an application, the correction service will store it in the dictionary 320. Next to each word is provided a list of application types that will be updated each time a word is added by a certain application. A standard dictionary contains mainly a list of words. A system-level dictionary contains words that were pushed by several applications. The correction service needs to associate words with application types, so corrections that are associated with the same application type would get a boost in ranking. In order to associate words with applications the dictionary stores, next to each word, a list of application types that pushed this word to the dictionary. Every time an application pushes a word to the dictionary, the word's list of application types is updated to include the relevant application type.

The system-level dictionary can be updated explicitly by an application. Applications can push data explicitly to the system-level dictionary while in search services, and the dictionary may be built from the data gathered from the system or predefined in the applications.

For example, in Microsoft Word (trade mark of Microsoft Corporation), the dictionary is composed of a fixed set of words together with words that have been set explicitly by the user. In web search engines, the dictionary is composed by words that have been gathered from passive applications and web sites. In the described service, applications may upload into the system-level dictionary their private dictionary from an application to make it available to other applications. Correction suggestions from a user defined dictionary, may be allocated a higher level of trust with respect to their correctness, i.e. they will be placed higher in the ranking because the system knows that those suggestions are correct for at least one application.

In an alternative or additional embodiment, the correction service may connect to a global dictionary provided via a network and may not maintain a system-level dictionary on its own local computer system. Such a global dictionary may include words and contexts generated for generic applications on computer systems.

FIG. 5 shows a schematic representation of an entry 500 in a system-level dictionary 320. The entry 500 is for a reference word c 510. The dictionary 320 includes a list of applications 512 in which the word c 510 is used, and a corresponding list of application types 514. A counter 516 is provided of the number of times a user has selected the word c 510 as a correction. A context 518 “a b c d” may be provided if the word c 510 has been added by a user.

Corresponding to the entry 500 in the dictionary 320, the search index 312 can provide a list of documents 520 on the computer system which include the word c 510 and the size of context set 522 in which the context “a b c d” is found in the document.

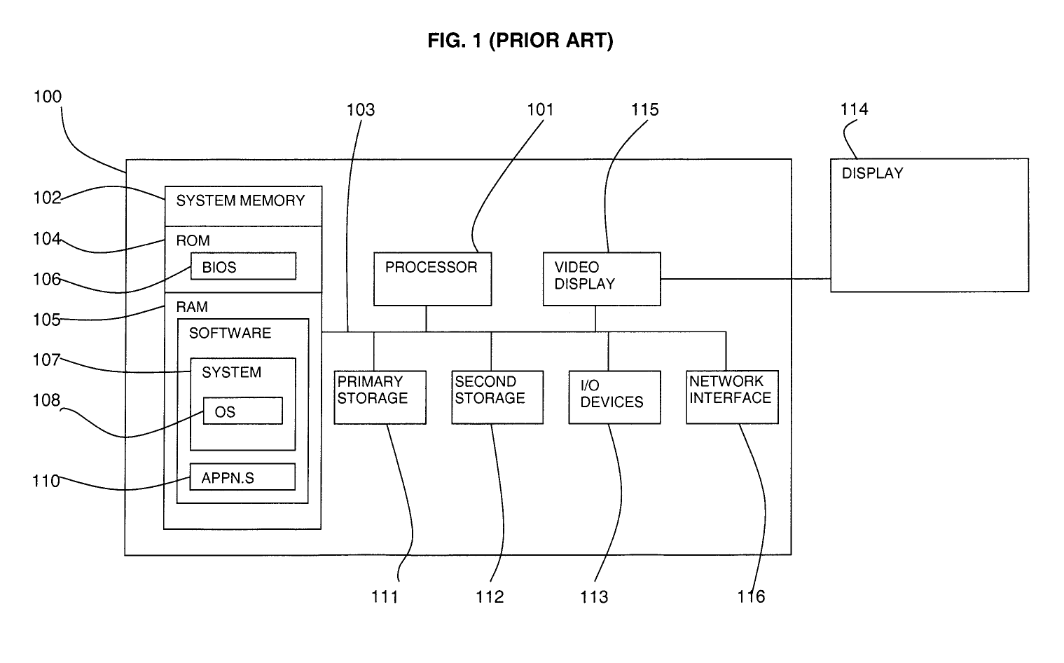

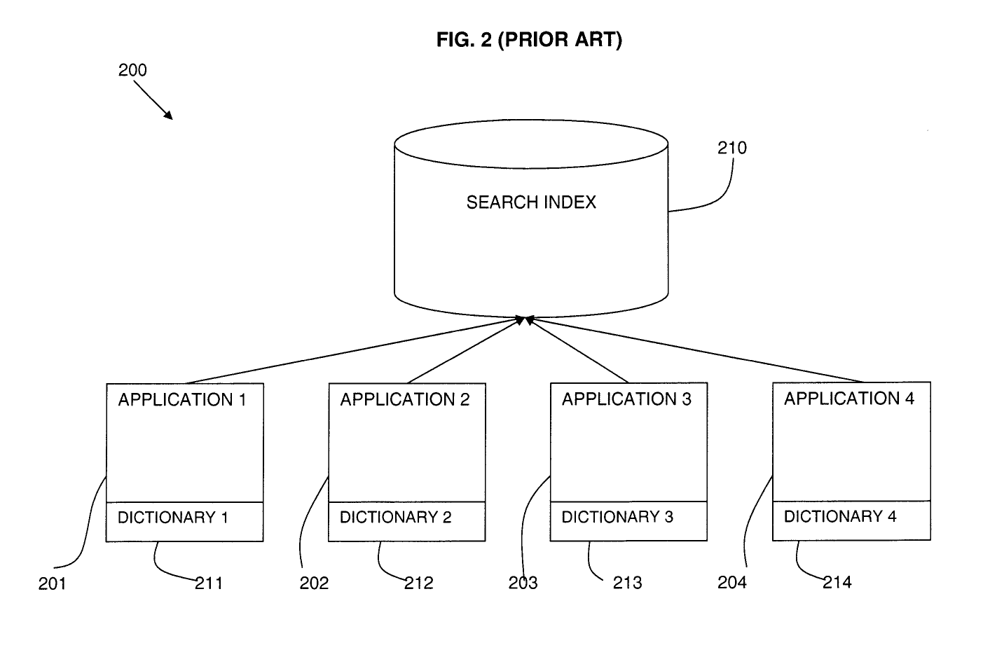

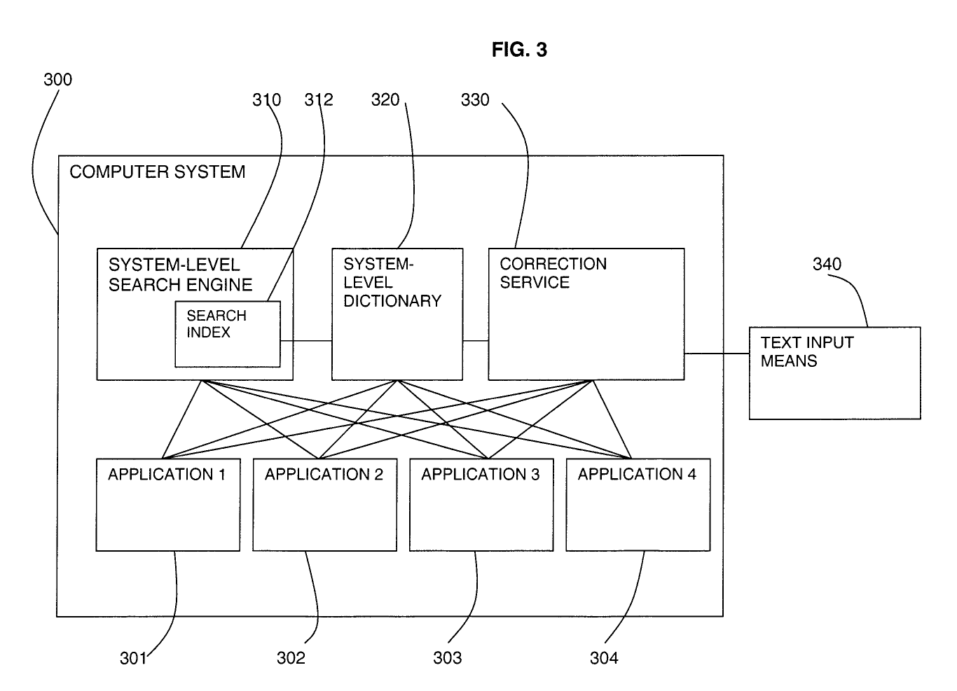

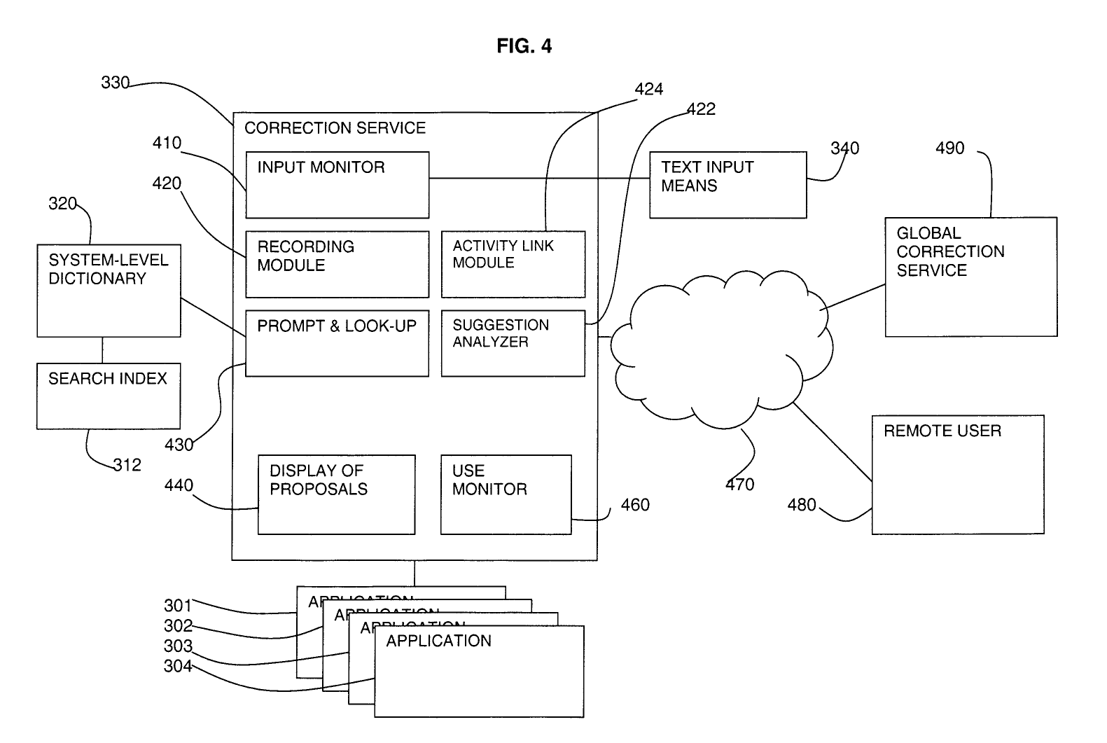

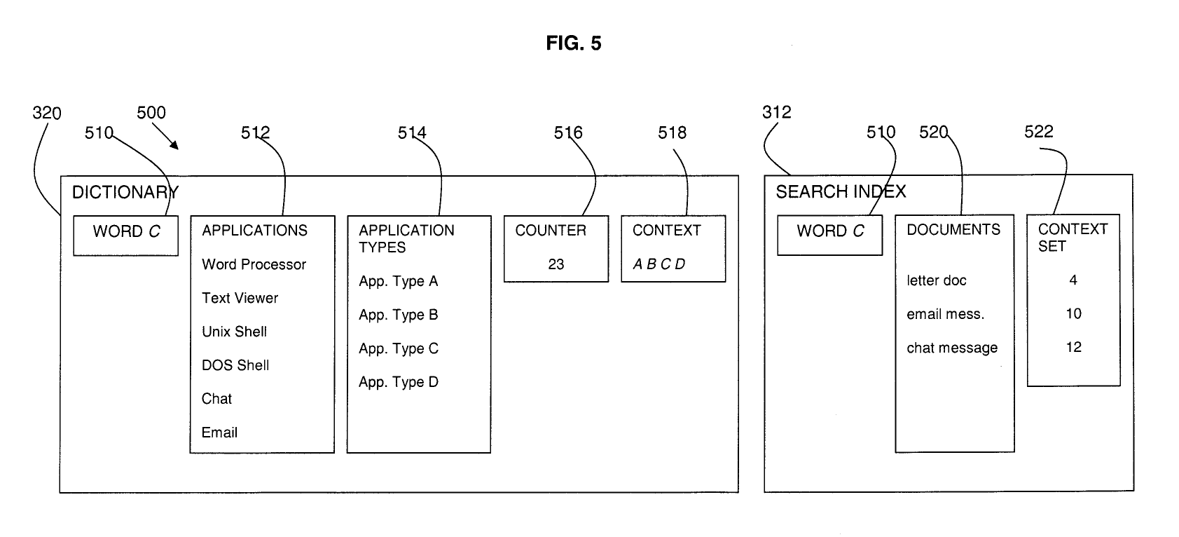

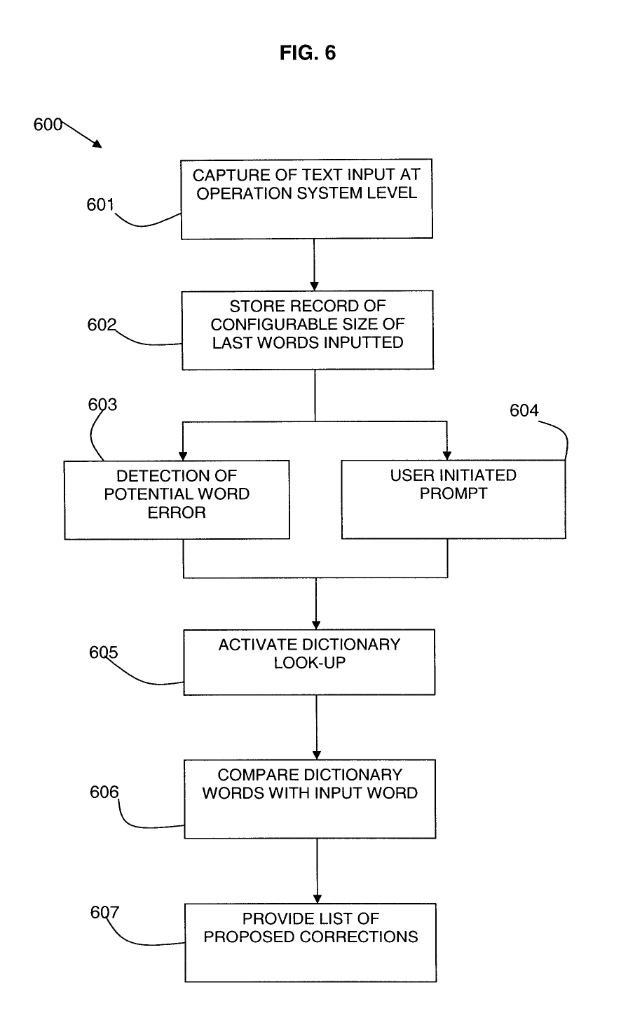

FIG. 6 is a flow diagram 600 showing a method of operation of a correction service. The correction service catches 601 input text at an operation system level on a computer system and saves a record 602 of configurable size of the last words input.

If either, the system detects 603 a potential error in the last word input, or the user uses a special key combination 604, then a dictionary look-up is activated 605. The contexts are compared 606 using the parameters of: the similarity of the correction to the corrected word; the application type; the context of the word; the document activities; and the user's history. A list of proposed corrections is provided 607, ranked according to the similarity of the parameters.

The correction service initiates an interactive session with the user whilst the user is working in any application. The user then may choose a correction, and the correction will be copied to the clipboard or even pasted automatically to the current application instead of the last word.

The system-level correction service, can also be used to scan through previously entered text in an application to highlight potential misspellings and to provide suggested proposals from the system-level dictionary.

The advantages of a system-level correction service include the following:
Any application can benefit from the correction service.
The dictionary used for correction updates automatically and contains a large wealth of information so that it is more likely to find corrections.
Given this large dictionary, ranking as described above is used to improve the relevance of the correction proposals.

A system-level correction service may be provided as a service to a customer over a network.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

Improvements and modifications can be made to the foregoing without departing from the scope of the present invention.

We claim:

1. A method for providing a correction service, comprising:
monitoring the input of text;
identifying an incorrect input word in a first application;
retrieving one or more correction proposal words from a system-level dictionary, wherein the system-level dictionary stores a reference word with an identifier of at least one application type in which the reference word is used; and
ranking the correction proposal words according to the similarity of the proposal word to the input word and by comparing the first application to the application types of the proposal word.

2. A method as claimed in claim 1, wherein proposal words with an application type of the first application are ranked higher in the correction proposal words than proposal words of a different application type.

3. A method as claimed in claim 1, wherein one or more words neighbouring the input word are recorded as a context of the input word, and the step of ranking includes comparing the context of the input word to the contexts of proposal words in documents on the computer system.

4. A method as claimed in claim 1, wherein a data structure is maintained linking documents relating to an activity, and the step of ranking includes ranking higher in the correction proposal words proposal words that are found in documents which relate to the same activity as the document of the input word.

5. A method as claimed in claim 1, including counting a number of times a word in the dictionary is selected as a correction to an input word, wherein the step of ranking increases the ranking of proposal words according to their count value.

6. A method as claimed in claim 1, wherein the step of monitoring the input of text monitors one or more of: key stroke inputs, character recognition, voice recognition, at a system level.

7. A method as claimed in claim 1, wherein the step of identifying an incorrect input word is automatic on detection of an unrecognised input word.

8. A method as claimed in claim 1, wherein the step of identifying an incorrect input word is initiated by a user.

9. A method as claimed in claim 1, wherein a system-level dictionary is built on a system-level search.

10. A system for providing a correction service, comprising:
a monitor of input of text on a computer system, including an identifier of an input word in a first application;
a system-level dictionary, wherein the dictionary stores a reference word with an identifier of at least one application type in which the reference word is used;
a means of comparing the input word and reference words in the system-level dictionary according to the similarity of a reference word to the input word and by comparing the first application to the application types of the reference word.

11. A system as claimed in claim 10, including:
a display of one or more correction proposal words from a system-level dictionary, ranked according to the output of the means of comparing the input word and reference words in the system-level dictionary.

12. A system as claimed in claim 11, wherein reference words with an application type of the first application are ranked higher in the correction proposal words than reference words of a different application type.

13. A system as claimed in claim 10, including a record of one or more words neighbouring the input word to provide a context of the input word, and the means of comparing includes comparing the context of the input word to the contexts of proposal words in documents on the computer system.

14. A system as claimed in claim 10, wherein a data structure is maintained linking documents relating to an activity, and the means of comparing includes comparing the activity of documents in which the reference words are found to the activity of the document of the input word.

15. A system as claimed in claim 10, including a counter in the system-level dictionary of a number of times a reference word in the dictionary is selected as a correction to an input word.

16. A method as claimed in claim 10, wherein the monitor of the input of text is of the form of one or more of: a key stroke monitor, a character recognition application, a voice recognition application.

17. A system as claimed in claim 10, wherein the system-level dictionary is built on a system-level search with applications pushing data to the dictionary.

18. A system as claimed in claim 10, wherein the system-level dictionary is accessed via a network.

19. A computer program product stored on a computer readable storage medium, comprising computer readable program code means for performing the steps of:
monitoring the input of text;
identifying an incorrect input word in a first application;
retrieving one or more correction proposal words from a system-level dictionary, wherein the system-level dictionary stores a reference word with an identifier of at least one application type in which the reference word is used; and
ranking the correction proposal words according to the similarity of the proposal word to the input word and by comparing the first application to the application types of the reference word.

20. A method of providing a service to a customer over a network, the service comprising:
monitoring the input of text;
identifying an incorrect input word in a first application;
retrieving one or more correction proposal words from a system-level dictionary, wherein the system-level dictionary stores a reference word with an identifier of at least one application type in which the reference word is used; and
ranking the correction proposal words according to the similarity of the proposal word to the input word and by comparing the first application to the application types of the reference word.
